(19) United States
(12) Patent Application Publication
(10) Pub. No.: US 2020/0054974 A1
(43) Pub. Date: Feb. 20, 2020

(54) SYSTEM, ARRANGEMENT AND METHOD FOR DETECTING DAMAGES WITH CONTINUOUS DISC FILTERS

(71) Applicant: VALMET TECHNOLOGIES OY, Espoo (FI)

(72) Inventors: Mika KARAILA, Tampere (FI); Joona NIKUNEN, Pirkkala (FI); Teemu ANTIKAINEN, Tampere (FI)

(21) Appl. No.: 16/608,969

(22) PCT Filed: Apr. 27, 2018
(86) PCT No.: PCT/FI2018/050311

§ 371 Date: Oct. 28, 2019

(30) Foreign Application Priority Data
Apr. 28, 2017 (FI) 20177056

(51) Int. Cl. B01D 35/143; B01D 29/00; B01D 29/41; B01D 33/23

(52) U.S. Cl. CPC B01D 35/1435; B01D 29/002; B01D 2201/56; B01D 33/23; B01D 29/413

(57) ABSTRACT

The invention relates to a system for detecting damages of filter fabric (8) with continuous disc filters (1) where the system comprises of pressure sensor element (41) that is attached into a filter sector (5) so that it measures the pressure inside (11) the filter sector and is connected with a CPU (42) and a radio unit (43) that periodically transmits the measured pressure values to a receiver (R) that receives the transmitted measurements and compares the measurements using processing means (55) with previously received values and detects damages by detecting significant pressure difference.

### FIELD The invention relates to a system, arrangement and method for detecting damages with continuous disc filters.

### BACKGROUND

Continuous disc filters are used in mining industry, metal processing, chemical industry, pulp and paper industry and other processes such as food and pharmaceutical manufacturing. Most advantageous applications are dewatering of solids which are free settling and form into an easily discharged, non blinding cake.

The U.S. Pat. No. 4,216,093 published in 1980 describes a sector based rotary suction disc filter. Main working principle is generating negative pressure that sucks the liquid through the sides of filter sectors and collects the solids so that they can be easily removed from the surface with blow. The filter sectors can also be covered with cloth or fabric that is exchangeable. Changing the filter fabric provides easy way of managing the filtering parameters of the disc filter and provides thus advantages over prior solutions.

The WO2014170533 describes a disc filter apparatus and method for controlling a disc filter. The WO2009076980 describes a filter device and method for operating a filter device.

The common problem with all continuous disc filters with fabric filter coating are the damages in the filter fabric. The damages are typically incisions that let the slurry inside the disc filter sectors and through the piping into the pumps. This can clog the piping and create excessive wear and additional faults. The inspection of filter fabric is done by a maintenance person checking each cake release standing next to the filter. This is typically time consuming and dirty job. A fault in filter cloth can also be detected measuring the purity of the filtrated fluid. Both ways lag on detection or provide incomplete information. There is a great need to detect the incisions automatically, accurately and as soon as possible.

### BRIEF DESCRIPTION

The present invention seeks to describe a system for detecting damages of filter fabric with continuous disc filters, where the system comprises of pressure sensor element that is attached into a filter sector so that it measures the pressure inside the filter sector and is connected with a CPU and a radio unit that periodically transmits the measured pressure values to a receiver that receives the transmitted measurements and compares the measurements using processing means with previously received values and detects damages by detecting significant pressure difference.

The invention describes also an arrangement for detecting damages of filter fabric with continuous disc filters, where a multitude of wireless pressure sensors are attached into disc filter sectors, each to its own sector so that the pressure sensing element can measure the pressure inside the sector and a common receiver located apart from the disc filter that can receive the measured values from all of the said pressure sensors and can compare with data processing arrangement the said measured values to detect damages by finding single significantly higher pressure than in other measurements.

The invention also shows a method for detecting damages of filter fabric with continuous disc filters, utilizing steps of measuring the pressure at least once per cycle, inside a filter sector using pressure sensing element and transmitting the measured pressure with wireless communication means to a receiver and comparing the received pressure value with previously received pressure values using processing arrangement and detecting a damage of filter cloth by finding a significant change with newly received pressure measurement compared to previous measurements.

### LIST OF DRAWINGS

Example embodiments of the present invention are described below, by way of example only, with reference to the accompanying drawings, in which

FIG. 1 shows disc filter; and

FIG. 2 shows one filter sector; and

FIG. 3 shows cut-through of a filter sector with wireless pressure sensor; and

FIG. 4 shows components of wireless pressure sensor; and

FIG. 5 shows arrangement for the invention; and

FIG. 6 shows steps for one embodiment.

### DESCRIPTION OF EMBODIMENTS

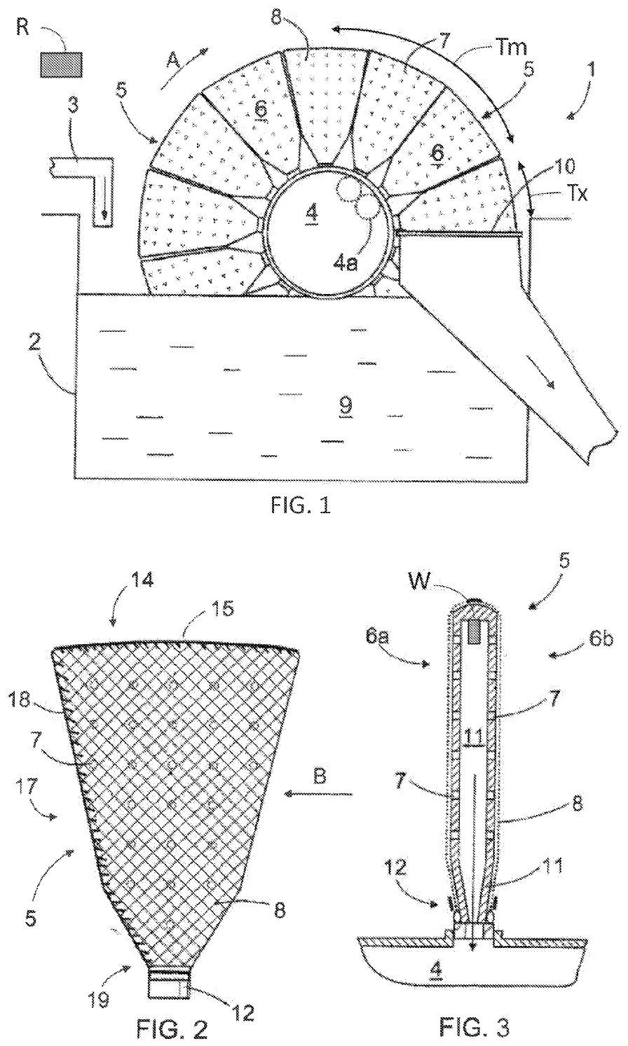

FIG. 1 shows a disc filter 1 that comprises a basin 2 to which a solution formed by solid matter and liquid is led from one or more supply channels 3. Further the disc filter comprises a body 4 rotatable around a horizontal axis. The body 4 comprises of several pipes 4a. On the outer circumference of the body, several essentially triangular sectors 5 are placed side by side so that the sectors form a relatively narrow disc-like structure around the body. One body can comprise several disc like structures of this type arranged at a desired distance from each other in the axial direction. The triangular side surface 6 of each sector 5 has openings 7. A filter fabric 8 or the like can be arranged against the side surface to act as a filtering layer. The body 4 of the disc filter is rotated around its axis in direction A, whereby each sector 5 at a time dips into the solution 9 in the basin. A negative pressure can be applied through the body 4 so that it affects also inside each sector 5. While the sector is dipped into the solution the negative pressure sucks the solution against the filter and liquid can pass through the filter and flow through the pressure flow channel 11 and through the neck 12 of the sector and on through the body pipelines 4a out of the disc filter. The solid matter in turn stays on the surface of the filtering fabric 8 from which it can be removed with doctoring blades or pressure medium jets or blown out using pressure pulse so that the solid “cake” is dropped in to opening 10 of discharge shaft before the next filtering cycle. A receiver R can be seen outside the actual disc filter 1. It can be attached to the disc filter static structures, but may also be located somewhere else.

FIGS. 2 and 3 shows a filtering sector 5. It is possible to arrange a filter fabric 8 on the filtering sector 5. The wide end of the filtering bag can have an installation opening 14 with closing element 15 such as zipper. There can be different arrangements of attaching filtering fabrics on top of the sector 5. Wireless pressure sensor W can be attached anywhere on the filtering sector 5. It can be inside the flow channel 11 or between the filter fabric 8 and the sector 5. It may also be inserted within the structure of the sector. Most important thing is that it can measure the pressure within 11 the sector.

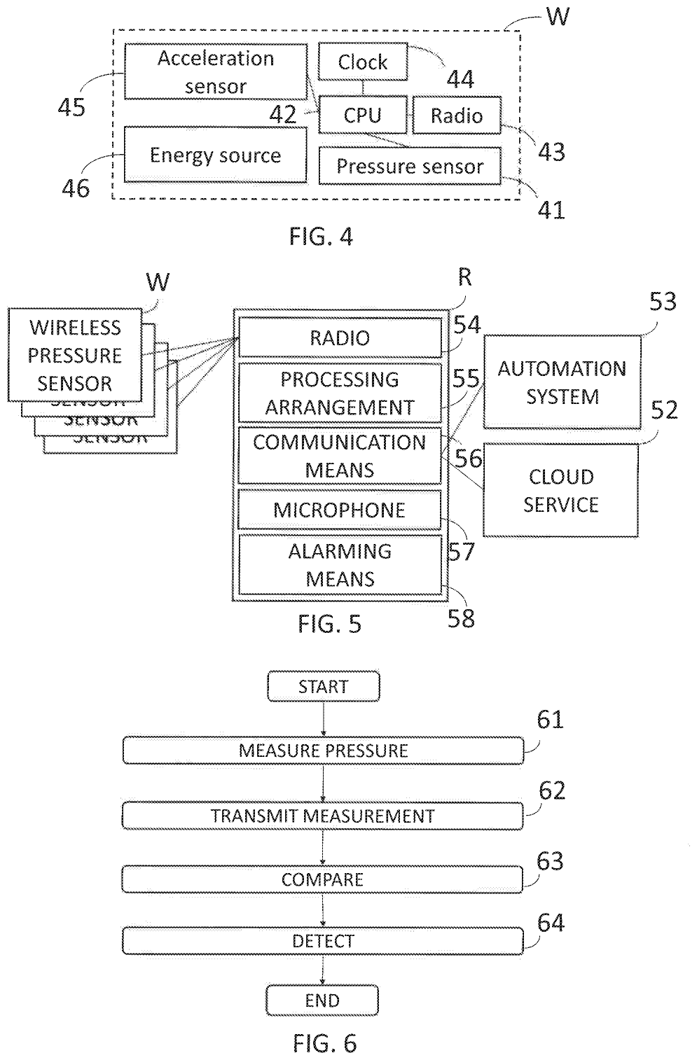

FIG. 4 shows components of wireless pressure sensor W. The actual pressure sensing element 41 can detect pressures in range of 20 kPa to 310 kPa. Alternatively, it may only detect the sucking pressure in range of 20 kPa to 60 kPa. The pressure sensor can be of any type, e.g. capacitive, piezoelectric, MEMS. Most important factor is the environment tolerance, accuracy and low energy consumption. The pressure sensor 41 is connected with CPU unit 42. The CPU unit may be an ARM processor or any other microchip capable of doing needed calculations. The CPU unit can also be a single chip solution with the radio 43. The radio 43 that is used in the wireless pressure sensor can be any low power radio available on the market. Currently such radios are Bluetooth, Bluetooth Low Energy, ZigBee, ZigBee Pro, EnOcean, Ant, Ant+, 6loWPAN and WiFi. A clock unit 44 may be part of the CPU chip or a separate chip. Most importantly the clock unit may be active even if the Radio and CPU units are in deep sleep mode. The acceleration sensor 45 can be a MEMS sensor that can detect the orientation of the wireless pressure sensor W by measuring earth's gravity. There can be different energy sources 46 inside the wireless pressure sensor. A battery or accumulator is simplest approach, but the energy source can also be an energy harvester that collects energy from temperature differences or vibrations. The radio solution can also be done using passive radios such as RFID. In this kind of solution, the energy source 46 is a wireless energy harvester antenna with needed electronics.

FIG. 5 is a view of an arrangement where several wireless pressure sensors W are connected to a receiver R that can further be connected to automation system or cloud service. The receiver R comprises of radio 54 that makes possible communication with wireless pressure sensors. The radio can manage connection to multiple wireless pressure sensors either by division of time, frequency or phase.

The receiver comprises also processing arrangement 55 that comprise of one or more processor and memory units. The processing arrangement may also comprise non-volatile memory to store parameters, received measures and calculated values.

The receiver may comprise communication means 56 that enable data connections between the receiver R and external systems. The communication can be done with cabled connections such as serial line, industrial bus or Ethernet connection. The communication can also be wireless and may need additional radio to enable the connectivity. There are many wireless protocols available e.g. Bluetooth, WiFi, cellular data, SigFox or LoRa.

The receiver may also comprise microphone 57 that can listen the sounds in the disc filter environment. The microphone can listen at least the frequencies of 400 Hz-3400 Hz. More preferably the bandwidth can be 300 Hz-7000 Hz. The microphone is connected with suitable A/D converters to digitalize the signal. The digitalized signal can be passed to processing arrangement 55.

The receiver may also comprise alarming means 58. These can be lights, loudspeakers, horns or screens. The lights can be set into a matrix shape to enable display symbols such as numbers and letters. The alarming means can be integrated into same package as the receiver R or they can be connected with cables or wireless links with receiver and located separately. The alarming means may also be a cellular modem that can send SMS or other type of instant message.

The receiver may also have additional configuration interface that can also be used to visualize received and calculated values. The configuration interface can be e.g. small screen with additional buttons or touch sensitive surface. The configuration interface can also be an external portable device such as laptop or smartphone which is connected to the receiver R using communication means 56.

The receiver R can be connected with the facility's automation system 53 using communication means 56. Any data, processed data and alarms handled by the receiver can be passed to the automation system. The automation system can visualize the data, merge the alarms with automation system alarm handling and store the historical values. The automation system can also be used to configure the receiver.

The receiver R can be connected with cloud service 52 using communication means 56. A cloud service is a processing arrangement that resides in the internet. A cloud service can provide different functions. It can store the data from multiple receivers. It can make calculations based on data. The calculations may be such as comparing values, detecting differences from averages, detecting slow deviations and detecting cyclical issues. The cloud service can provide reports and alarms depending on detections. The receiver R may act as a gateway and pass all data from wireless pressure sensors W directly to cloud service.

FIG. 6 shows steps for one embodiment. In this embodiment, the wireless pressure sensor W measure the pressure 61 inside the sector 11. The measured value is transmitted 62 to the receiver R. The receiver listens and compares 63 the values. And the receiver detects 64 a damage of filter fabric 8 by finding a significant change with newly received pressure measurement compared to previous measurements.

The wireless pressure sensor W measures the internal pressure of a sector. This internal pressure depends on filtered solution, used filter cloths and pumps. This pressure is typically most of the time between 25 kPa-35 kPa or 10 kPa-50 kPa. If overpressure is used for releasing of the cake the pressure is raised for a moment to 200 kPa-350 kPa for releasing the cake. For detecting damages of the filter fabric 8 it is important to measure the pressure during the period when the sector is above the liquid 9 level and before the release of the cake. Most preferably the measurement should be done Tm between the time the sector is in its upmost position and release of the cake. The measurement can be done in very fast manner so that a snapshot of the pressure is captured. It can also be done with 4-6 sequential measurement that are done within 1-2 seconds. By doing this the peak values can be removed and the rest averaged. This result is the comparable detection pressure. There are several different ways to detect the correct moment for getting the comparable detection pressure. When only a pressure sensor is available, it is possible to detect the cake release pressure and once we know the rotating speed from the sequence of release pressures, it is possible to adjust the timing for obtaining the comparable detection pressure a short time e.g. 1-10 seconds before release of the cake. Another option is to use acceleration sensor 45 to detect the moment when the sector is in its upmost position. This is possible if the wireless pressure sensor is attached to the sectors so, that it is possible to measure the orientation of the wireless pressure sensor using earth's gravity as reference. Once the comparable detection pressure has been measured it can be transmitted immediately to the receiver R. Alternatively the transmission can be postponed until it is better moment for transmission. A best moment for transmission Tx is when the cake has been released. For a short period of time the sector is nor covered with the solid matter neither it is dipped into solution or hidden behind the static structures of the disc filter.

The wireless pressure sensor can use all possible power saving functions during the cycle of the disc. Once the rotating speed is detected there is no need to activate sensors 41, 45, radio 43 or CPU 42 more often than when they are actually used. The clock 44 can be used to activate the sensors and CPU at right moment. This way the energy consumption can be minimized. A new detection of rotating speed can be done frequently, e.g. once per day or week.

The wireless pressure sensor can transmit at least the ID and pressure measurement to the receiver. It may also transmit, but not limiting to following things: status of energy source, orientation, rotating speed, temperature, vibrations, RSSI value and internal status. The internal status may include information about software, processor, chip temperature, IO status and memory status.

The receiver R listens for radio transmissions and stores messages coming from wireless pressure sensors. The receiver stores the pressure measurement with ID for further processing. The newly read pressure measurement is compared to other received and stored values for detecting damages.

A typical case is to compare pressure values from sectors 5 on one disc. There are several mathematical ways to compare the pressure values, but they are all targeting to detect one significantly higher pressure than the other pressures. One example is to compare the pressures is looking for the range of the values of other pressures and adding 10% into it. If the newly received pressure does not fit into the added range and is higher than any other pressures, a damage is probable and alarm is triggered. Another example is to use statistical distribution as basis for the comparison. When one of the pressure values differs from confident distribution of all other pressure values we can detect a problem on certain sector. If the pressure is significantly higher than the standard deviation of all others there is probably an incision in the filter fabric. The pressure difference that is needed to detect the incision depends on used suction pressure and filter cloth. E.g. allowed pressure range can be 36 and values outside that creates alarm. An alarm indicating the damaged sector may be triggered. The pressure value can also be similarly compared to previous readings from the same sector. The receiver may store multiple previous values for calculation purposes. A minimum of 2 previous values is used for comparison. The maximum amount of values depends on memory of the receiver and CPU usage. If sporadic changes towards higher pressure are detected it can be interpreted as incision in the filter fabric and alarm may be triggered. Hard limits such as low limit of 20 kPa, high limit of 55 kPa and high-high limit of 90 kPa can also be used to trig alarms. Low limits can be used to detect problems with malfunction of cleaning the cloth or clogging of flow channels 11. Higher limits provide immediate alarms related to damaged cloths.

It is also possible to detect the clogging of the supply channels 3 or basin 2. This is possible by comparing the average of pressures over all sectors 5 between different discs that reside on the same body 4. The average pressure of all sectors of one disc is compared to average pressure of all sectors of the next disc and if the average pressure value of the second disc is over ±5% apart from average pressure values from previous disc it can be an effect of clogging. This information can be reported or even alarm can be triggered.

The receiver R may also use the microphone 57 to detect damages with filter fabrics 8. The microphone can be listening the audio environment and catching short e.g. 0.5 sec.-1 sec. sound samples periodically e.g. every 5 seconds or every 10 seconds. The samples can be handled with FFT and stored as audio frequency spectrums over the available band. The spectrums are running averaged over some period e.g. several minutes or hours. After every received transmission, the receiver access the previous audio frequency spectrum and compares the spectrum with the stored average spectrum. If the received pressure value is outside of the range of the reading from other sectors in the same disc or outside of ±16 of the measurement from the same disc and the comparison of spectrum shows at least one new peak with within small band e.g. 50 Hz or 100 Hz, the system may trigger alarm. This way even smaller incisions can be detected.

The receiver R may also forward either the captured sound sample or the spectrum to a cloud service 52. This way it is possible to store large amount of sound samples or spectrums with related pressure values for further processing. By using learning algorithms, the sound samples or spectrums can be combined with relevant information about the damages of the disc filter. This combination can be called as fingerprint. Every new sample can be compared against known fingerprints and alarms can be triggered if similarity is found.

One disc filter body 4 may accommodate up to 14 disc filters that can comprise up to 14 sectors. Each of the sector may have own wireless pressure sensor W and these can communicate to one receiver R. It is even possible to have two or more disc filter bodies arranged close to each other so that one receiver can listen the signals from all of the wireless pressure sensors. There can be up to 600 wireless pressure sensors transmitting data to one receiver. This approach need good addressing for the wireless pressure sensors. The addressing is needed to distinguish the correct sector when alarm triggers. Addressing connects the individual wireless pressure sensor IDs' with the sectors, discs and bodies they are attached. The addressing is done every time a new wireless pressure sensor is attached into sector. This can be done manually using visual markings in the wireless pressure sensors or assisted with NFC tags integrated with wireless pressure sensors.

Having an alarm indicating the damaged cloth is important. This can be done in multiple ways. Here the addressing of the ID's is assisting, but not mandatory on all cases. When the damage is detected by receiver R, it can use the alarming means 58 to provide a visual or audible signal every time it receives the transmission from the wireless pressure sensor. If the transmission is done when the cake has been released, it is straightforward to look for the damaged sector during the audible or visual alarm. If the addressing has been done, it is obvious to display the address of the damaged sector with screen or send it via message.

1. A system for detecting a damage of a filter fabric in a continuous disc filter, the system comprises
a CPU,
a pressure sensor for measuring pressure values, the pressure sensor being attached to a filter sector and connected with the CPU,
a radio unit for transmitting the measured pressure values and
a receiver for receiving the measured pressure values and comparing them in order to detect a damage by detecting a significant pressure difference.

2. (canceled)

3. The system as claimed in claim 1, wherein the system comprises an integrated acceleration sensor.

4. (canceled)

5. A system for detecting a damage of a filter fabric in a continuous disc filter, the system comprises
a multitude of wireless pressure sensors for measuring pressure values, the pressure sensors being attached to disc filter sectors, each sensor being attached to its own sector and
a common receiver located apart from the disc filter for receiving the measured pressure values from all of said pressure sensors and comparing them in order to detect a damage by detecting a significant difference in the measured pressure values.

6. The system as claimed in claim 5, wherein the receiver comprises alarming means for visually and/or audibly inform users about a detected damage.

7. The system as claimed in claim 5, wherein the receiver comprises communication means for transmitting the measured pressure values and/or fingerprints of the detected damages to an automation system or a cloud service.

8. A method for detecting a damage of a filter fabric in a continuous disc filter, the continuous disc filter comprises a basin including liquid and solid matter up to a liquid level and a body that comprises on its outer circumference filter sectors that are placed side by side around the body, each filter sector comprising a filter fabric on its surface, the body rotates cycles around its horizontal axis in such a manner that the sectors are dipped into the basin one after another as the body rotates and a cake is formed of the solid matter on the surface of the filter fabric and thereafter released, the method comprising:
measuring a pressure value inside a filter sector at least once per cycle when the sector is above the liquid level by using a pressure sensor,
transmitting the measured pressure values by using a radio unit to a receiver,
comparing the newly received measured pressure value with the previously received measured pressure values by using a processing arrangement,
detecting a damage of a filter fabric by detecting a significant change between the newly received measured pressure value compared to the previously received measured pressure values.

9. The method as claimed in claim 8, further comprising:
listening to an audible spectrum with a microphone of the receiver
transforming short audio samples into audio frequency spectrums
comparing by using a processing arrangement the newest audio frequency spectrum with the previously stored averaged audio frequency spectrums and
detecting by using the processing arrangement a damage of a filter fabric by combining the found change with the newly received measured pressure value and at least one new peak in small band in the audio frequency spectrum.

10. The method as claimed in claim 8, further comprising:
listening to an audible spectrum with a microphone of the receiver
storing frequently short audio samples
transmitting by using communication means fingerprints comprising the stored audio samples with their relevant damage information to a cloud service
comparing within the cloud service the newly received audio sample with the fingerprints from the previously transmitted audio samples
detecting a damage of a filter fabric by detecting similarities between the fingerprints that are known as samples from damaged filters and the newly received audio sample.

11. The system as claimed in claim 2, wherein the system comprises an internal clock for activating the CPU, the pressure sensor and the acceleration sensor.

12. The method as claimed in claim 8, wherein the method comprises detecting a positive pressure peak indicating releasing of the cake.

13. The method as claimed in claim 12, wherein the method comprises timing of measuring a pressure value 1 to 10 seconds before releasing of the cake.

14. The method as claimed in claim 8, wherein the method comprises activating the pressure sensor by detecting by an acceleration sensor when the sector is in upright position.
